(19) United States
(12) Patent Application Publication
(10) Pub. No.: US 2014/0326330 A1
(43) Pub. Date: Nov. 6, 2014

(54) WHEELED MATERIAL DISTRIBUTING MACHINERY

(71) Applicants: HUNAN SANY INTELLIGENT CONTROL EQUIPMENT CO., LTD, Changsha (CN); SANY HEAVY INDUSTRY CO., LTD., Changsha (CN)

(72) Inventors: Xin Xu, Changsha (CN); Haiyun Jia, Changsha (CN)

(73) Assignees: HUNAN SANY INTELLIGENT CONTROL EQUIPMENT CO., LTD, Changsha (CN); SANY HEAVY INDUSTRY CO., LTD., Changsha (CN)

(21) Appl. No.: 14/273,872

(22) Filed: May 9, 2014

Related U.S. Application Data
(63) Continuation of application No. PCT/CN2012/073834, filed on Apr. 11, 2012.

(30) Foreign Application Priority Data
Nov. 18, 2011 (CN) 2011103687337

(51) Int. Cl. B05B 15/02

(52) U.S. Cl. CPC B05B 15/025
USPC 137/351

(57) ABSTRACT

In one aspect of the present disclosures, a wheeled material distributing machinery includes a main travel system, a boom system, and a material distributing frame, where an inner end of a root end boom of the boom system is connected to the material distributing frame, the main travel system is mounted on a predetermined boom of the boom system. In a travel state, the main travel system is supported on a road surface, and at least part of the weight of the boom system and at least part of the weight of the material distributing frame act on the main travel system. In a predetermined working state, the material distributing frame is supported on a working surface, and the entire weight of the boom system and the entire weight of the main travel system both act on the material distributing frame.

### CROSS-REFERENCE TO RELATED APPLICATIONS

This application is a continuation application of International Patent Application No. PCT/CN2012/073834, filed Apr. 11, 2012, entitled “WHEELED MATERIAL DISTRIBUTION MACHINERY”, by Xin Xu et al., which itself claims the priority to Chinese Patent Application No. 201110368733.7, filed Nov. 18, 2011, entitled “WHEELED MATERIAL DISTRIBUTING MACHINERY”, by Xin Xu et al., the disclosures for which are hereby incorporated herein in their entireties by reference.

### FIELD OF THE DISCLOSURE

The present disclosure relates generally to the field of machinery, and more particularly to a wheeled material distributing machinery.

### BACKGROUND OF THE INVENTION

Owing to its convenience in usage and powerful functions, the pump truck has become a widely applied wheeled material distributing machinery. Referring to FIG. 1, FIG. 1 is an overall schematic structural view of a pump truck in the prior art. The figure shows a structure of a pump truck in a predetermined working state. A pump truck generally includes a travel system 100, a pumping system 300′, and a boom system 200. The travel system 100 is a vehicle chassis, and the vehicle chassis includes a vehicle frame and multiple wheel assemblies mounted on the vehicle frame. The vehicle chassis guarantees the safety of the pump truck during travel and satisfies the transition requirement of the pump truck. The pumping system 300′ and the boom system 200 are both mounted on the vehicle chassis. The pumping system 300′ includes a drive cylinder, a delivery cylinder, a reversing valve, and a hopper, and is capable of pumping materials with a certain pressure. The boom system 200 includes multiple boom sections and a delivery pipeline; the multiple boom sections include a root end boom, a tail end boom, and other booms located between the root end boom and the tail end boom. The booms are hinge-connected in sequence through a horizontal hinge-connecting shaft; an inner end of the root end boom is connected to an underframe of the vehicle chassis through a slewing mechanism; an inner end of the delivery pipeline is connected to a pumping port of the pumping system 300′, and an outer end thereof extends to an outer end of the tail end boom along the boom.

The pump truck has a travel state and a working state. In the travel state, the pumping system 300′ stops pumping materials, and the boom system 200 is folded above the vehicle chassis. At this time, the transition operation can be performed using the vehicle chassis, so that the pump truck transits from one construction field to another. In the predetermined working state, the vehicle chassis is placed in a horizontal way, and is fixed relative to a working surface; the boom system 200 is unfolded, the root end boom is connected to the vehicle chassis, and the outer end of the tail end boom extends outward. The pumping system 300′ delivers concrete or other materials to the outer end of the tail end boom through the pumping port and the delivery pipeline. Generally, the pump truck is also provided with an outrigger mechanism connected to the chassis, the vehicle chassis is supported on the ground through the outrigger mechanism. The outrigger mechanism is capable of providing a large support span for the pump truck, so as to improve the working stability of the pump truck. A position of the outer end of the tail end boom can be changed by changing an included angle between adjacent booms, so that the materials reach a predetermined position and are distributed in a predetermined range.

As shown in FIG. 1, the pump truck is in a predetermined working state; when a material distributing operation is performed, the vehicle chassis is placed in a horizontal way and occupies a corresponding space in the construction field. At present, with a more demanding construction requirement and an increasingly compact construction field, the space occupied by the vehicle chassis increases the field used by the pump truck, and lowers the adaptability of the pump truck. In many cases, as the field site cannot accommodate the vehicle chassis, the construction manner has to be changed, and in an even worse case, the predetermined construction operation has to be implemented by using other machineries. This problem not only occurs on the pump truck, but also on a wheeled material distributing frame of the travel system or other wheeled material distributing machineries. Therefore, how to improve the adaptability of the wheeled material distributing machinery is a technical problem to be solved by persons skilled in the art at present.

In addition, in a pump truck, the pumping system 300′ and the boom system 200 are both mounted on the vehicle chassis; hence, the bearing capacity and travel safety of the vehicle chassis pose corresponding requirements on the pumping system 300′ and boom system 200, and limit the weight and contour profile size of the pumping system 300′ and boom system. Furthermore, the pumping capability of the pumping system 300′ and the material distributing radius of the boom system 200 are both limited. Currently, with the development of the construction techniques, the pump truck is required to have a more powerful pumping capability and a larger material distributing radius; hence, the current pump truck fails to meet the current construction requirement. As for the material distributing frame with a travel system, the vehicle chassis also limits the weight and contour profile size of the boom system. Therefore, how to improve the pumping capability and/or material distributing radius of the wheeled material distributing machinery is also a technical problem to be solved by persons skilled in the art at present.

Therefore, a heretofore unaddressed need exists in the art to address the aforementioned deficiencies and inadequacies.

### SUMMARY OF THE INVENTION

Accordingly, an objective of the present disclosure is to provide a wheeled material distributing machinery with stronger adaptability; the wheeled material distributing machinery may be a pump truck or a material distributing frame, which is not only capable of performing a transition operation, but also capable of performing a material distributing operation.

A further objective of the present disclosure is to provide a wheeled material distributing machinery that is no longer restricted by a vehicle chassis, thereby making it possible to improve a material distributing radius and/or a pumping capability.

In one aspect of the present disclosure, a wheeled material distributing machinery includes a main travel system and a boom system, and further includes a material distributing frame; an inner end of a root end boom of the boom system is connected to the material distributing frame; the main travel system is mounted on a predetermined boom of the boom system; in a travel state, the main travel system is supported on a road surface, and at least part of the weight of the boom system and at least part of the weight of the material distributing frame act on the main travel system; in a predetermined working state, the material distributing frame is supported on a working surface, and the entire weight of the boom system and the entire weight of the main travel system both act on the material distributing frame from above.

In one embodiment, the predetermined boom is the root end boom of the boom system.

In one embodiment, the main travel system includes a vehicle frame and multiple axle assemblies mounted on a vehicle frame; the vehicle frame is fixedly mounted on the predetermined boom of the boom system.

In one embodiment, the main travel system includes multiple axle assemblies, the axle assemblies are mounted on the predetermined boom of the boom system, and at least one of the multiple axle assemblies is an axle assembly capable of steering.

In one embodiment, at least one of the axle assemblies is an axle assembly having an independent drive mechanism.

In one embodiment, the material distributing frame includes a slewing mechanism, the slewing mechanism includes a rotary component and a fixed component that form a rotatable fit, and the rotary component is connected to the inner end of the root end boom.

In the predetermined working state, a slewing centerline of the slewing mechanism is perpendicular to a horizontal plane.

In one embodiment, the rotary component is hinge-connected to the inner end of the root end boom through a root end hinge-connecting shaft; the axis of the root end hinge-connecting shaft is perpendicular to the slewing centerline; in the predetermined working state, the axis of the root end hinge-connecting shaft is parallel with the horizontal plane; a boom drive mechanism is further included, the boom drive mechanism is located between the root end boom and the rotary component, and drives the root end boom to rotate about the axis of the root end hinge-connecting shaft relative to the rotary component.

In one embodiment, in the travel state, the slewing centerline of the slewing mechanism is parallel with or forms an acute angle with the horizontal plane; at least three outrigger mechanisms are further included; an inner end of at least one of the outrigger mechanisms is hinge-connected to a rotating block through an outrigger hinge-connecting shaft; the rotating block is hinge-connected to the fixed component through a rotary hinge-connecting shaft; the axis of the outrigger hinge-connecting shaft is perpendicular to the axis of the rotary hinge-connecting shaft; the axis of the rotary hinge-connecting shaft is parallel with the slewing centerline; in the predetermined working state, the axis of the outrigger hinge-connecting shaft is parallel with the horizontal plane, and the material distributing frame is supported on the working surface through the outrigger mechanism.

In one embodiment, an inner end of the at least one outrigger mechanism is hinge-connected to the fixed component through the outrigger hinge-connecting shaft, and the axis of the outrigger hinge-connecting shaft is perpendicular to the slewing centerline.

In one embodiment, in the travel state and predetermined working state, the slewing centerline of the slewing mechanism is perpendicular to the horizontal plane; at least three outrigger mechanisms are further included; inner ends of the outrigger mechanisms are hinge-connected to the fixed component through the outrigger hinge-connecting shaft; the axis of the outrigger hinge-connecting shaft is parallel with the slewing centerline; in the predetermined working state, the material distributing frame is supported on the working surface through the outrigger mechanism.

In one embodiment, the wheeled material distributing machinery further includes a pumping assembly connected to the material distributing frame, and the pumping assembly includes a pumping system and a pump auxiliary travel system connected to the pumping system.

In one embodiment, the material distributing frame includes a slewing mechanism; the slewing mechanism includes a rotary component and a fixed component that form a rotatable fit; the rotary component is connected to the inner end of the root end boom; the slewing centerline of the slewing mechanism is perpendicular to the horizontal plane in both the in travel state and predetermined working state; in the travel state and/or predetermined working state, a pumping support of the pump auxiliary travel system is connected to the fixed component through a middle hinge-connecting shaft, and the axis of the middle hinge-connecting shaft is perpendicular to the horizontal plane.

In one embodiment, the wheeled material distributing machinery further includes an outrigger mechanism with an inner end hinge-connected to the pumping support through an outrigger hinge-connecting shaft, and the axis of the outrigger hinge-connecting shaft is parallel with the axis of the middle hinge-connecting shaft.

In one embodiment, the wheeled material distributing machinery further includes a turning drive mechanism connected to the boom system; when the wheeled material distributing machinery is switched from the travel state to the predetermined working state, the turning drive mechanism is supported on the ground, and the turning drive mechanism drives the boom system to turn.

In one embodiment, the wheeled material distributing machinery further includes a turning drive mechanism connected to the material distributing frame; when the wheeled material distributing machinery is switched from the travel state to the predetermined working state, the turning drive mechanism is supported on the ground, and drives the material distributing frame, or the boom system and the material distributing frame to turn.

In one embodiment, the wheeled material distributing machinery further includes an outrigger auxiliary travel system, and the outrigger auxiliary travel system is mounted on at least one of the outrigger mechanisms; in the travel state, the outrigger auxiliary travel system is supported on the road surface, and the weight of the at least one of the outrigger mechanisms acts on the outrigger auxiliary travel system.

In one embodiment, the wheeled material distributing machinery further includes an operating cab located on the outrigger mechanism; the operating cab includes a travel control mechanism, and the travel control mechanism is capable of controlling operation of the main travel system.

In one embodiment, the wheeled material distributing machinery further includes a frame auxiliary travel system, and an axle assembly of the frame auxiliary travel system is mounted on the material distributing frame; in the travel state, the axle assembly of the frame auxiliary travel system is supported on the road surface.

In one embodiment, the wheeled material distributing machinery further includes a state detection sensor and a controller, the state detection sensor is used to detect a state of the root end boom, and the controller outputs a position signal according to a detection signal of the state detection sensor.

In one embodiment, the state detection sensor is a tilt-angle sensor, and the tilt-angle sensor detects a tilt angle of the root end boom; the controller determines whether state switching is completed according to a detection result of the tilt-angle sensor, and when it is determined that the state switching is completed, outputs a predetermined position signal.

In one embodiment, the wheeled material distributing machinery further includes an operating cab located on the predetermined boom of the boom system; the operating cab includes a travel control mechanism, and the travel control mechanism is capable of controlling operation of the main travel system.

Another wheeled material distributing machinery provided in the present disclosure includes a main travel system and a boom system, and further includes a material distributing frame; a root end boom of the boom system is hinge-connected to the material distributing frame through a root end hinge-connecting shaft; the main travel system is mounted on a predetermined boom of the boom system; the boom system and the main travel system are capable of rotating around the axis of the root end hinge-connecting shaft relative to the material distributing frame.

In one embodiment, the wheeled material distributing machinery further includes a pumping assembly connected to the material distributing frame; the pumping assembly includes a pumping system and a pump auxiliary travel system connected to the pumping system; the pumping system is in communication with a delivery pipeline of the boom system through piping.

In one embodiment, the material distributing frame includes a rotary component and a fixed component that form a rotatable fit, and the rotary component is hinge-connected to an inner end of the root end boom through the root end hinge-connecting shaft.

In one embodiment, the main travel system includes multiple axle assemblies; the axle assembly is mounted on the predetermined boom of the boom system; at least one of the multiple axle assemblies is an axle assembly capable of steering.

In one embodiment, the wheeled material distributing machinery further includes at least three outrigger mechanisms; an inner end of at least one of the outrigger mechanisms is hinge-connected to a rotating block through an outrigger hinge-connecting shaft; the rotating block is hinge-connected to the material distributing frame through a rotary hinge-connecting shaft; the axis of the outrigger hinge-connecting shaft is perpendicular to the axis of the rotary hinge-connecting shaft; an inner end of at least another outrigger mechanism is hinge-connected to the material distributing frame through the outrigger hinge-connecting shaft, and the axis of the outrigger hinge-connecting shaft is perpendicular to the axis of the rotary hinge-connecting shaft.

In one embodiment, the wheeled material distributing machinery further includes at least three outrigger mechanisms; inner ends of the outrigger mechanisms are hinge-connected to the material distributing frame through the outrigger hinge-connecting shaft; in a predetermined working state, the axis of the outrigger hinge-connecting shaft is perpendicular to a horizontal plane.

In one embodiment, the wheeled material distributing machinery further includes an operating cab located on the predetermined boom or the outrigger mechanisms of the boom system; the operating cab includes a travel control mechanism capable of controlling operation of the main travel system.

Another wheeled material distributing machinery provided in the present disclosure includes a main travel system and a boom system, and further includes a material distributing frame; a root end boom of the boom system is connected to the material distributing frame; the main travel system is mounted on a predetermined boom of the boom system through a removable mechanism.

A wheeled material distributing machinery provided in the present disclosure includes a main travel system for performing a transition operation and a boom system for performing material distributing construction, and further includes a material distributing frame; an inner end of a root end boom of the boom system is connected to the material distributing frame; the main travel system is mounted on a predetermined boom of the boom system; in this way, the wheeled material distributing machinery is capable of performing state switching. During state switching, the main travel system is movable along with the predetermined boom. In the travel state, the main travel system is supported on a road surface, and at least part of the weight of the boom system and at least part of the weight of the material distributing frame act on the main travel system. In this way, the transition of the machinery is easily implemented through the main travel system, thereby maintaining the flexibility of the machinery transition operation. According to an actual requirement, the main travel system is enabled to turn along with the predetermined boom, so that the wheeled material distributing machinery is switched to a predetermined working state. In the predetermined working state, the material distributing frame is supported on a working surface, and the entire weight of the boom system and the entire weight of the main travel system both act on the material distributing frame from above. In this way, the main travel system is supported on the material distributing frame, and is no longer supported on the working surface, so as to reduce the space occupied by the main travel system, and reduce the field occupied by the wheeled material distributing machinery in the predetermined working state; the wheeled material distributing machinery is also capable of performing material distributing task in a field with a small construction space, thereby improving the adaptability of the wheeled material distributing machinery.

In a further specific technical solution, the main travel system is connected to the root end boom of the boom system; in this way, the adverse impact generated by the main travel system during unfolding of the boom system is reduced, so that other booms of the boom system are unfolded easily, facilitating the unfolding operation of the boom system.

In a further specific technical solution, the main travel system includes multiple axle assemblies. The multiple axle assemblies are mounted on the predetermined boom of the boom system; the multiple axle assemblies include at least one steering axle assembly. In the travel state, multiple axle assemblies are connected through the predetermined boom; the predetermined boom implements the function of the main travel system vehicle frame, and the steering axle assembly is capable of implementing the steering of the main travel system, facilitating the transition of the wheeled material distributing machinery; in a predetermined working state, the predetermined boom implements the material distributing function. Therefore, unlike the prior art in which the vehicle frame of the main travel system only plays the corresponding role in the travel state, and the predetermined boom of the boom system only plays the corresponding role in the predetermined working state, in the wheeled material distributing machinery, the predetermined boom is capable of playing different roles in two states, and has two functions, thereby making better use of the predetermined boom of the boom system. As the vehicle frame of the main travel system is omitted, the weight and manufacturing cost of the wheeled material distributing machinery are reduced, the energy consumption during transition is reduced, and the use cost is reduced while the material distributing capability is maintained. The importance lies in that, the designed speed of the wheeled material distributing machinery obtained through the technical solution is lowered, thereby forming the wheeled specific machinery in Safety Technical Conditions for Vehicle Travel. While ensuring safe travel, the wheeled specific machinery vehicle can have a greater outer contour profile size. In this way, the limit of the vehicle chassis on the material distributing radius of the current wheeled material distributing machineries such as the pump truck is eliminated. Furthermore, the boom system can have a larger size, so that the material distributing radius is increased, and the material distributing capability is improved. If the wheeled material distributing machinery includes a pumping system, the technical solution enables the pumping system to have a larger size, thereby making it possible to improve the pumping capability thereof. The technical solution makes it possible to improve the pumping capability and the material distributing radius.

In a further specific technical solution, the material distributing frame includes a slewing mechanism, and in the case where the inner end of the root end boom is hinge-connected to a first component of the slewing mechanism through a root end hinge-connecting shaft, the wheeled material distributing machinery further includes a boom drive mechanism, and the boom drive mechanism is capable of driving the root end boom to rotate about the axis of the root end hinge-connecting shaft relative to the rotary component. In this way, when the wheeled material distributing machinery is switched from a travel state to a predetermined working state, the material distributing frame is first fixed on a predetermined working surface, and then the root end boom is enabled to rotate about the axis of the root end hinge-connecting shaft relative to the rotary component through the boom, so that the entire boom system and the main travel system rotate upward. The wheeled material distributing machinery defined in the technical solution is capable of performing state switching automatically to implement the state switching of the machinery, thereby improving the operation convenience and operation efficiency of the wheeled material distributing machinery.

In a further specific technical solution, outrigger mechanisms hinge-connected to the material distributing frame are further included. In the technical solution, it is unnecessary to set a predetermined working surface fitting with the material distributing frame; the fixing with the material distributing frame is easily implemented using the outrigger mechanisms, thereby making it possible to turn the boom system.

In a further specific technical solution, in the travel state, at least one of the outrigger mechanisms acts on the road surface through the outrigger auxiliary travel system; in addition, the pumping system is supported on the road surface through the pump auxiliary travel system. In this way, the load of the main travel system is reduced, the weight of the wheeled material distributing machinery is reasonably shared, and the travel flexibility of the wheeled material distributing machinery is improved.

In a further specific technical solution, a state detection sensor and a controller are further included. The state detection sensor is used to detect a state of the root end boom; the controller outputs a position signal according to a detection signal of the state detection sensor. In this way, the turning accuracy of the wheeled material distributing machinery is ensured, and at the same time the efficiency of the turning operation is improved.

Another wheeled material distributing machinery provided in the present disclosure includes a main travel system and a boom system, and further includes a material distributing frame. The root end boom of the boom system is connected to the material distributing frame. The main travel system is mounted on the predetermined boom of the boom system through the removable mechanism. The wheeled material distributing machinery defined in the present disclosure is capable of separating the main travel system and the boom system during state switching, thereby improving the adaptability of the wheeled material distributing machinery, and realizing the objective of the present disclosure.

These and other aspects of the present disclosure will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment.

FIG. 1 is an overall structural view of a pump truck in the prior art, and shows a structure when the pump truck is in a predetermined working state.

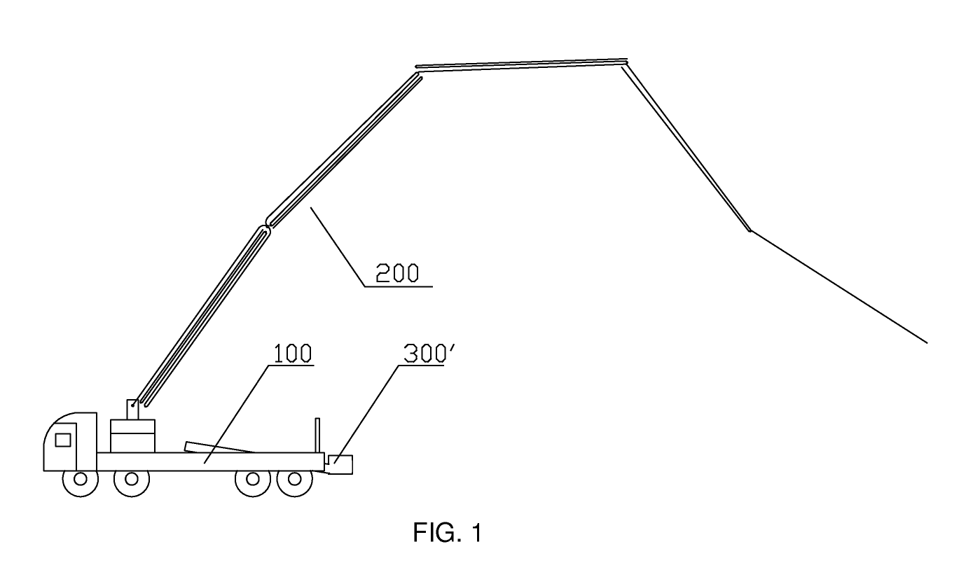

FIG. 2 is a schematic structural view of a wheeled material distributing machinery according to Embodiment 1 of the present disclosure, and shows a structure of the wheeled material distributing machinery in a travel state.

FIG. 3A is a state schematic structural view of an unfolded outrigger mechanism when a wheeled material distributing machinery according to Embodiment 1 of the present disclosure is switched from a travel state to a predetermined working state.

FIG. 3B is an enlarged schematic structural view of I-I part in FIG. 3A.

FIG. 4 is a schematic structural view of a wheeled material distributing machinery in a predetermined working state according to Embodiment 1 of the present disclosure.

FIG. 5 shows a wheeled material distributing machinery according to Embodiment 2 of the present disclosure, and is a schematic structural view of the wheeled material distributing machinery in a travel state.

FIG. 6 is a schematic structural view of an unfolded outrigger mechanism in a wheeled material distributing machinery according to Embodiment 2 of the present disclosure.

FIG. 7 is a schematic structural view of a wheeled material distributing machinery in a predetermined working state according to Embodiment 2 of the present disclosure.

FIG. 8 is a schematic structural view of a wheeled material distributing machinery according to Embodiment 3 of the present disclosure.

### DETAILED DESCRIPTION OF THE INVENTION

The present disclosure will now be described more fully hereinafter with reference to the accompanying drawings, in which exemplary embodiments of the disclosure are shown.

This disclosure may, however, be embodied in many different forms and should not be construed as limited to the embodiments set forth herein. Rather, these embodiments are provided so that this disclosure will be thorough and complete, and will fully convey the scope of the disclosure to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present disclosure.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “with” when used herein, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom”, “upper” or “top,” and “front” or “back” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as with a meaning that is consistent with their meaning in the context of the relevant art and the present disclosure, and will not be interpreted in an idealized or overly formal sense unless expressly so defined herein.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

The description will be made as to the embodiments of the present disclosure in conjunction with the accompanying drawings. In accordance with the purposes of this disclosure, as embodied and broadly described herein, this disclosure, in one aspect, relates to a wheeled material distributing machinery. To make the description easier, the axle assembly in this specification includes an axle and a wheel, and the axle may be mounted on a corresponding mechanism through a method in the prior art. The specific form of the axle may be a specific structure in the prior art based on an actual requirement, for example, a steering axle, a driving axle, a steer-driving axle, and a support axle; alternatively, an axle having an independent drive mechanism may be formed. The axle assembly may include one wheel, and may also include two or four wheels. The mounting manner of the wheel may be a deploying manner in the prior art, so as to achieve a predetermined function and satisfy the actual requirement.

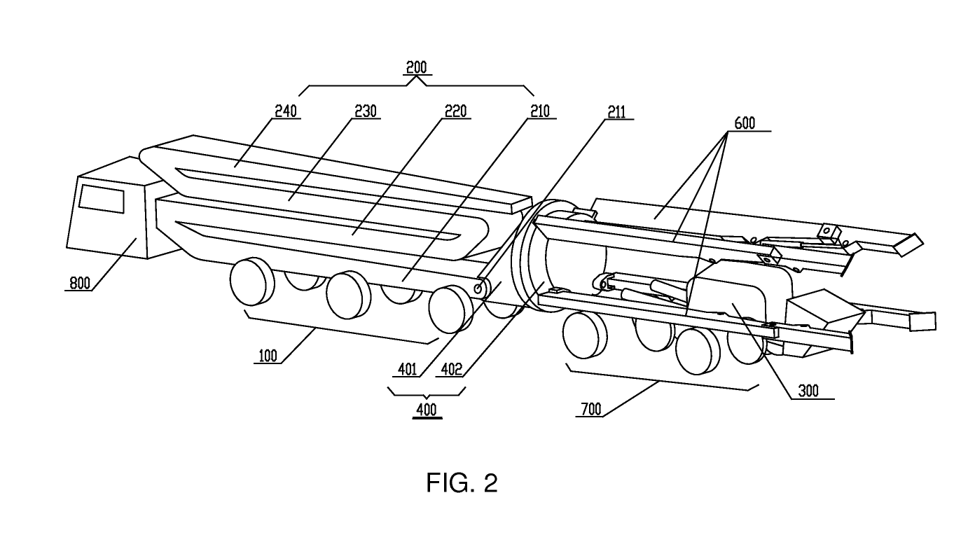

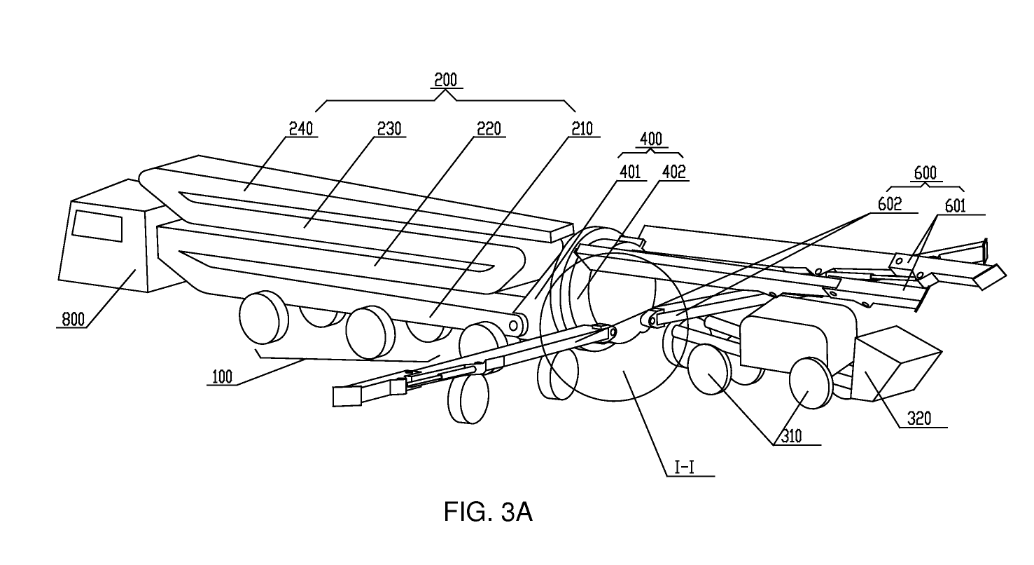

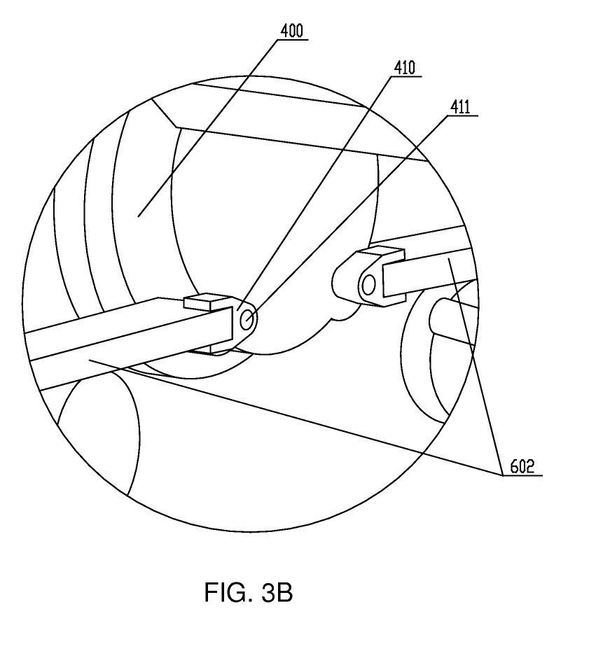

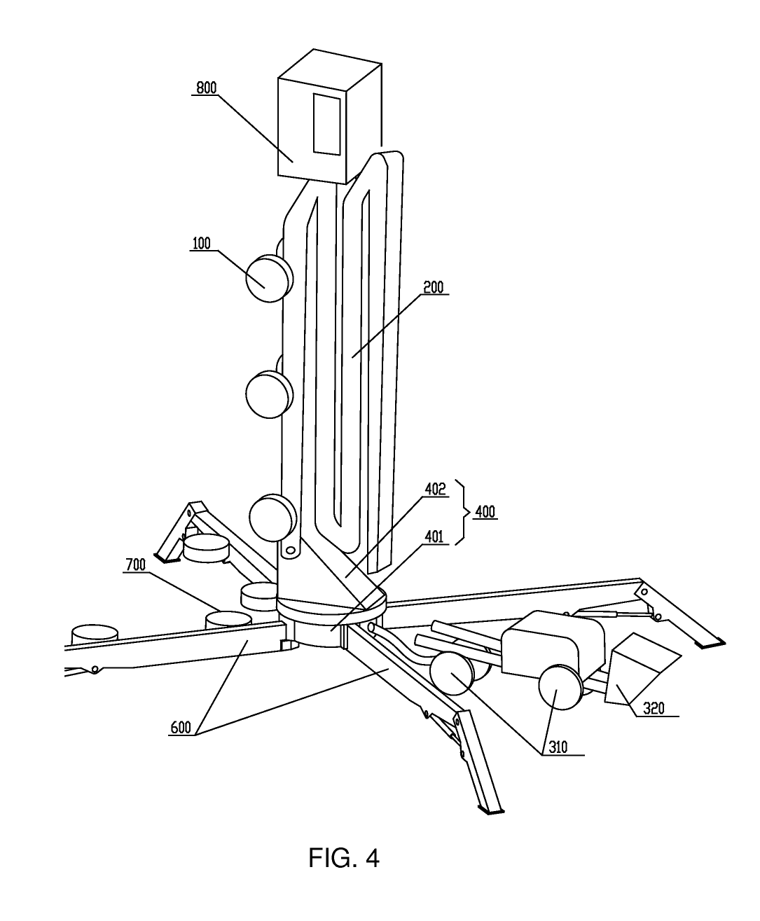

Referring to FIG. 2 to FIG. 4, FIG. 2 shows a schematic structural view of a wheeled material distributing machinery according to Embodiment 1 of the present disclosure, and shows a structure when the wheeled material distributing machinery is in a travel state; FIG. 3A is a state schematic structural view of an unfolded outrigger mechanism when a wheeled material distributing machinery according to Embodiment 1 of the present disclosure is switched from a travel state to a predetermined working state; and FIG. 4 is a schematic structural view of a wheeled material distributing machinery according to Embodiment 1 of the present disclosure in a predetermined working state.

The wheeled material distributing machinery includes a main travel system 100, a boom system 200, and a pumping assembly 300; the wheeled material distributing machinery is capable of performing material distributing and material pumping. In this embodiment, the boom system 200 includes four boom sections hinge-connected in sequence through a horizontal hinge-connecting shaft. The four boom sections are a root end boom 210, a second boom 220, a third boom 230, and a fourth boom 240. A pumping system 320 included in the pumping assembly 300 may be the same as an existing pumping system, and may include components such as a hopper, a delivery cylinder, and a hydraulic oil. The pumping system 320 may be provided with an independent power system, so as to independently drive the pumping system 320 to rotate.

The main travel system 100 includes multiple axle assemblies, and differs from the prior art in that the multiple axle assemblies are directly mounted on the root end boom 210 of the boom system 200; the multiple axle assemblies may be disposed in an axle arrangement manner of an existing vehicle chassis, and may also be disposed according load distribution of the wheeled material distributing machinery. An axle assembly capable of steering may be set as the axle assembly in the front part. It is understandable that with at least one of the axles being an axle assembly capable of steering and with proper arrangement of the axle assembles, the steering operation of the main travel system 100 can be realized, ensuring or improving the flexibility of the main travel system 100. In the travel state, the multiple axle assemblies of the main travel system 100 contact a road surface, and are supported on the road surface. The main travel system 100 may use an existing power system, and distribute power in an existing manner; alternatively, at least one of the axles may be enabled to have an independent drive mechanism. In addition, the main travel system 100 may also be dragged by other power apparatuses or machineries.

The wheeled material distributing machinery further includes a material distributing frame 400. The material distributing frame 400 includes a slewing mechanism. The slewing mechanism includes a rotary component 401 and a fixed component 402 that form a rotatable fit, and the rotatable fit forms a slewing centerline of the slewing mechanism. The inner end of the root end boom 210 of the boom system 200 is connected to the rotary component 401. In this way, the boom system 200 is capable of rotating about the slewing centerline of the slewing mechanism relative to the material distributing frame 400. The slewing mechanism may be provided with an existing drive mechanism, to drive the rotary component 401 to rotate relative to the fixed component 402. A relationship between the slewing centerline of the slewing mechanism and the horizontal plane may be determined according to an actual requirement; the slewing centerline and the horizontal plane may form a predetermined acute angle or parallel with each other. As shown in FIG. 2, in this embodiment, in the travel state, the slewing centerline of the slewing mechanism is parallel with the horizontal plane; the multiple booms of the boom system 200 are folded on the main travel system 100. In order to adjust relative positions of the root end boom 210 and the material distributing frame 400 conveniently, the inner end of the root end boom 210 may further be hinge-connected to the rotary component 401 of the slewing mechanism through a root end hinge-connecting shaft 211, to form a hinge-connection structure. Corresponding to the hinge-connection structure, a turning hydraulic cylinder may be used as a boom drive mechanism, and two ends of the turning hydraulic cylinder may be hinge-connected to the root end boom 210 and the rotary component 401 respectively; the turning hydraulic cylinder is telescopic, so that the root end boom 210 rotates about the axis of the root end hinge-connecting shaft 211 relative to the rotary component 401, thereby changing the relative positions of the root end boom 210 and the material distributing frame 400. The wheeled material distributing machinery further includes four outrigger mechanisms 600. The outrigger mechanisms 600 may belong to the prior art, and use one more of slide hinge-connection, perpendicular axis hinge-connection, and horizontal axis hinge-connection. In the travel state, the four outrigger mechanisms 600 extend backward in a basically parallel manner. Referring to FIG. 3A, to facilitate state switching of the wheeled material distributing machinery, two outrigger mechanisms 601 at the upper part and two outrigger mechanisms 602 at the lower part are connected to the material distributing frame 400 in difference manners. Inner ends of the two outrigger mechanisms 601 at the upper part are hinge-connected to the material distributing frame 400 through an outrigger hinge-connecting shaft, and the axis of the outrigger hinge-connecting shaft is perpendicular to the slewing centerline.

With reference to FIG. 3B in combination with FIG. 3A, where FIG. 3B is an enlarged schematic structural view of I-I part in FIG. 3A, inner ends of the outrigger mechanisms 602 at the lower part are hinge-connected to a rotating block 410 through an outrigger hinge-connecting shaft (not shown in the figure). The rotating block 410 is hinge-connected to the material distributing frame 400 through a rotary hinge-connecting shaft 411; the axis of the outrigger hinge-connecting shaft is perpendicular to the axis of the rotary hinge-connecting shaft 411, and the rotary hinge-connecting shaft 411 is parallel with the slewing centerline.

As shown in FIG. 2, in order to keep the balance of the outrigger mechanisms 600, an outrigger auxiliary travel system 700 may further be provided. The outrigger auxiliary travel system 700 is mounted on the two outrigger mechanisms 602 at the lower part. In the travel state, the outrigger auxiliary travel system 700 is supported on the road surface, and the weight of the two outrigger mechanisms 602 at the lower part acts on the outrigger auxiliary travel system 700. In this embodiment, the outrigger auxiliary travel system 700 consists of four axle assemblies, and two of the axle assemblies are directly mounted on the two outrigger mechanisms 602 at the lower part, so that the corresponding axle assembly bears the load formed by the outrigger mechanism 602.

Referring to FIG. 3A, to facilitate the transition of the pumping system 320, in this embodiment, the pumping assembly 300 is further provided with a pump auxiliary travel system 310, and the pump auxiliary travel system 310 is connected to the pumping system 320; the pump auxiliary travel system 310 also consists of multiple axle assemblies, and each axle assembly may be mounted on a delivery cylinder of the pumping system 320. In the travel state, the pumping system 320 is connected to the material distributing frame 400 in a towing manner, and the pump auxiliary travel system 310 is supported on the road surface; the weight of the pumping system 320 acts on the pump auxiliary travel system 310. In the travel state, the weight of the entire wheeled material distributing machinery acts on the main travel system 100, the outrigger auxiliary travel system 700 and the pump auxiliary travel system 310, thereby conveniently implementing the transition of the machinery, and ensuring the flexibility and adaptability of the wheeled material distributing machinery.

Referring to FIG. 3A and FIG. 4, when the wheeled material distributing machinery is switched from the travel state to a predetermined working state, the two outrigger mechanisms 602 at the lower part may be unfolded towards two sides first, and then, the boom system 200 and the material distributing frame 400 are kept being locked; subsequently, the boom system 200, the main travel system 100 and the material distributing frame 400 are enabled to turn through a crane or other auxiliary machineries. During turning, the two outrigger mechanisms 601 at the upper part are unfolded towards outside from the slewing centerline; when the root end boom 210 of the boom system 200 is basically perpendicular to the working surface, the outrigger mechanism 602 is enabled to rotate about the axis of the rotary hinge-connecting shaft 411 for an appropriate angle, and the positions of the two outrigger mechanisms 602 at the lower part are adjusted, so that the four outrigger mechanisms 600 are all arranged around the slewing centerline; then, outer ends of the four outrigger mechanisms 600 are supported on the working surface, and inner ends thereof are blocked at a proper position of the material distributing frame 400, so that the entire wheeled material distributing machinery is fixed with respect to the working surface and switched to the predetermined working state. At this time, the entire weight of the boom system 200 and the entire weight of the main travel system 100 both act on the material distributing frame 400 from above, and the material distributing frame 400 is supported on the working surface through four outrigger mechanisms 600. Then, the locking between the boom system 200 and the material distributing frame 400 is released, and the boom system 200 may be enabled to rotate about a slewing center of the slewing mechanism relative to the material distributing frame 400 in an existing manner, and the booms of the boom system 200 may also be enabled to unfold in an existing manner, so as to perform a material distributing task.

In the predetermined working state, the main travel system 100 is supported on the material distributing frame 400 through the root end boom 210, and is no longer supported on the working surface, so as to reduce the construction field occupied by the main travel system 100, and further reduce the field occupied by the wheeled material distributing machinery in the predetermined working state; the pumping and material distributing tasks can also be performed in a field with a small construction space, thereby improving the adaptability of the wheeled material distributing machinery. It is understandable that, in the travel state, the main travel system 100 is supported on the road surface, and at least part of the weight of the boom system 200 and at least part of the weight of the material distributing frame 400 act on the main travel system 100; in the predetermined working state, the material distributing frame 400 is supported on the working surface through the outrigger mechanisms 600, so that the entire weight of the boom system 200 and the entire weight of the main travel system 100 act on the material distributing frame 400, thereby making it possible to improve the adaptability of the wheeled material distributing machinery. Definitely, the material distributing frame 400 is fit with a suitable working surface, so that the material distributing frame 400 is fixed on the working surface, thereby omitting the outrigger mechanisms, which also achieves the objective of the present disclosure. Definitely, the main travel system 100 may also employ an existing vehicle chassis structure, in which the main travel system 100 includes a vehicle frame and multiple axle assemblies mounted on the vehicle frame, and the vehicle frame is fixedly connected to the root end boom 210 of the boom system 200. In this way, in the predetermined working state, the entire vehicle chassis and the root end boom 210 can turn upward at the same time, thereby reducing the field occupied by the wheeled material distributing machinery in the predetermined working state, achieving the objective of the present disclosure.

In this embodiment, the main travel system 100 includes multiple axle assemblies, and the axle assemblies are directly mounted on the root end boom 210. In the travel state, the multiple axle assemblies are connected through the root end boom 210, and the root end boom 210 implements the function of the vehicle frame of the main travel system 100; in the predetermined working state, the root end boom 210 implements the material distributing function. Therefore, unlike the prior art in which the vehicle frame of the main travel system 100 only plays the corresponding role in the travel state, and the root end boom 210 of the boom system only plays the corresponding role in the predetermined working state, in the wheeled material distributing machinery provided in the present disclosure, the root end boom 210 is capable of playing different roles in two states, and has two functions, thereby making better use of the root end boom 210 of the boom system 200. The vehicle frame of the main travel system 100 is omitted because the root end boom 210 plays different roles in different states, thereby reducing the weight and manufacturing cost of the wheeled material distributing machinery, reducing the energy consumption during transition, and reducing the use cost while maintaining the material distributing capability. The importance lies in that, the designed speed of the wheeled material distributing machinery obtained through the technical solution is lowered, thereby forming the wheeled specific machinery in Safety Technical Conditions for Vehicle Travel. While ensuring safe travel, the wheeled material distributing machinery can have a greater outer contour profile size. In this way, the limit of the vehicle chassis on the pumping capability and material distributing capability of a pump truck in the prior art is eliminated, so that the pumping system 320 of the wheeled material distributing machinery has a larger size, hence making it possible to improve the pumping capability; the boom system 200 can also have a larger size and a greater material distributing radius, hence making it possible to improve the material distributing capability. Furthermore, the wheeled material distributing machinery makes it possible to improve the pumping capability and the material distributing radius.

In this embodiment, the working state is a state in which pumping and material distributing can be performed. The wheeled material distributing machinery provided in this embodiment is not limited to working in the working state described above, but can perform pumping and material distributing in another working state based on an actual requirement. For example, when a material distributing area is small and the boom system 200 is not required to unfold completely, the wheeled material distributing machinery may perform a construction task in another working state; at this time, the main travel system 100 may contact the ground (or contact the ground through an appropriate outrigger mechanism), and only the second boom 220, the third boom 230, and the fourth boom 240 are enabled to unfold, so that at least part of the weight of the boom system 200 acts on the main travel system 100. By changing positions of the second boom 220, the third boom 230, and the fourth boom 240, material distributing can be performed in a predetermined area.

According to the above description, it is understandable that the axle assembly of the main travel system 100 is not limited to being mounted on the root end boom 210, and the axle assembly may also be mounted on other booms. The travel function of the main travel system 100 is guaranteed by properly setting a structure of the axle assembly and a position relationship among folded booms. In addition, the material distributing frame 400 is not limited to including a slewing mechanism; as long as the connection between the root end boom 210 and the material distributing frame 400 is ensured, the objective of the present disclosure can also be achieved.

Definitely, according to an actual requirement, related components may be arranged. For example, the pumping system 320 may be connected to the material distributing frame 400 or boom system 200 in other existing manners; in the travel state, at least part of the weight of the pumping system 320 may act on the outrigger mechanisms 600, thereby omitting the pump auxiliary travel system 310; the outrigger mechanisms 600 are not limited to extending backward, but can also extend forward, so that at least part of the weight of the outrigger mechanisms 600 directly or indirectly acts on the main travel system 100 (at this time, a proper blocking mechanism is disposed in the corresponding working state, so that the material distributing frame 400 can be blocked on upper surfaces of the inner ends of the outrigger mechanisms 600, and the material distributing frame 400 can be supported on the working surface through the outrigger mechanisms 600).

In addition, the mounting manner between the outrigger mechanisms 600 and the material distributing frame 400 is not limited to the manner described above; when the wheeled material distributing machinery includes three outrigger mechanisms 600, as long as an inner end of at least one of the outrigger mechanisms 600 is connected to the material distributing frame 400 through the rotating block 410, relative positions of the three outrigger mechanisms 600 can be adjusted, so as to form three support points not on the same straight line, implementing the support for the material distributing frame 400. Definitely, each outrigger mechanisms 600 may be connected to the material distributing frame 400 through the rotating block 410. In order to ensure the stability of the support provided by the multiple outrigger mechanisms 600 for the material distributing frame 400, in a preferable technical solution, the inner end of at least one of the outrigger mechanisms 600 may be hinge-connected to the material distributing frame 400 through the outrigger hinge-connecting shaft, and the axis of the outrigger hinge-connecting shaft is kept perpendicular to the slewing centerline. Corresponding to the structure of the material distributing frame 400, the inner end of each outrigger mechanism 600 is hinge-connected to the material distributing frame 400 through the outrigger hinge-connecting shaft. In the predetermined working state, the axis of the outrigger hinge-connecting shaft is perpendicular to the horizontal plane, so as to adjust the support position of each outrigger mechanism 600.

To facilitate state switching of the wheeled material distributing machinery, the wheeled material distributing machinery may further be provided with a detection system, and the detection system may include a state detection sensor and a controller; the state detection sensor is used to detect a state of the root end boom 210; the controller outputs a position signal according to a detection signal of the state detection sensor, so that operation personnel are capable of determining the state of the root end boom 210 according to the position signal outputted by the controller. The state detection sensor may directly detect the height of the center of gravity of the root end boom 210, and may also determine the state of the root end boom 210 through detecting whether the main travel system 100 contacts the working surface (the road surface), or determine the state of the root end boom 210 through detecting a position relationship between the root end boom 210 and the material distributing frame 400. In this embodiment, the state detection sensor is a tilt-angle sensor, and the tilt-angle sensor detects a tilt angle of the root end boom 210; the controller determines whether the root end boom 210 is perpendicular to the working surface or is parallel with the working surface according to a detection result of the tilt-angle sensor, thereby determining whether the state switching is completed. When determining that the state switching is completed, the controller sends a predetermined position signal. The controller may send a position signal when the wheeled material distributing machinery is switched from the corresponding working state to the travel state, and send another position signal when the wheeled material distributing machinery is switched from the travel state to the corresponding working state; hence, based on different position signals, the operation personnel may determine whether the state switching is completed.

In order to ensure the working stability of the wheeled material distributing machinery, a counter weight disposed on related parts is further included, for example, a counter weight connected to the material distributing frame and/or the outrigger mechanism may be disposed, to balance the force applied on the entire machinery.

Referring to FIG. 2 to FIG. 4, the wheeled material distributing machinery according to Embodiment 1 of the present disclosure further includes an operating cab 800 located at the outer end of the root end boom 210 of the boom system 200; the operating cab 800 may include a travel control mechanism and a pumping control mechanism; the travel control mechanism may control operation of the main travel system 100, and the pumping control mechanism is capable of controlling operation of the pumping system 320. In this way, in the travel state, the operation personnel may stay in the operating cab 800 to control operation of the main travel system 100, facilitating the transition of the wheeled material distributing machinery; in the corresponding working state, the operation personnel may stay in the operating cab 800 to control operation of the pumping system 320.

To reduce the dependency of the wheeled material distributing machinery on other auxiliary machinery devices, an independent turning drive mechanism may be disposed. For example, the wheeled material distributing mechanism may further include a turning cylinder with an end connected to a corresponding boom of the boom system 200; when the wheeled material distributing machinery is switched from the travel state to the working state, another end of the turning cylinder is supported on the ground, so that the turning cylinder is stretched, thereby driving the boom system 200 to turn. Definitely, during state switching, the boom system 200 and the material distributing frame 400 may maintain a locking relationship, so that the material distributing frame 400 also is turned when the boom system 200 is turned. Definitely, the turning cylinder may also be connected to the material distributing frame 400; when the wheeled material distributing machinery is switched from the travel state to the corresponding working state, an end of the turning cylinder is supported on the ground and then stretched, thereby driving the material distributing frame 400 to turn, or driving the boom system 200 and the material distributing frame 400 to turn at the same time. Definitely, the turning drive mechanism is not limited to being implemented through a turning cylinder, and may also be implemented through other existing mechanisms, such as a lever mechanism and a pulley mechanism.

In the wheeled material distributing machinery according to Embodiment 1, during state switching, it is necessary to switch a position of the material distributing frame 400, so that the slewing centerline of the slewing mechanism is switched from a position parallel with the horizontal plane to a position perpendicular to the horizontal plane; to facilitate the position switching of the material distributing frame 400, it is necessary to dispose a hinge-connection structure between the outrigger mechanisms 600 and the material distributing frame 400 according to the foregoing description. In this way, the outrigger mechanisms 600 and the structure between the outrigger mechanisms 600 and the material distributing frame 400 become very complex, which not only affects the support rigidity of the outrigger mechanisms 600 and lowers the reliability of the outrigger mechanisms 600, but also makes the state switching complex. To simply the structure of the outrigger mechanisms 600 and facilitate the state switching of the wheeled material distributing machinery, Embodiment 2 of the present disclosure provides a wheeled material distributing machinery having another structure.

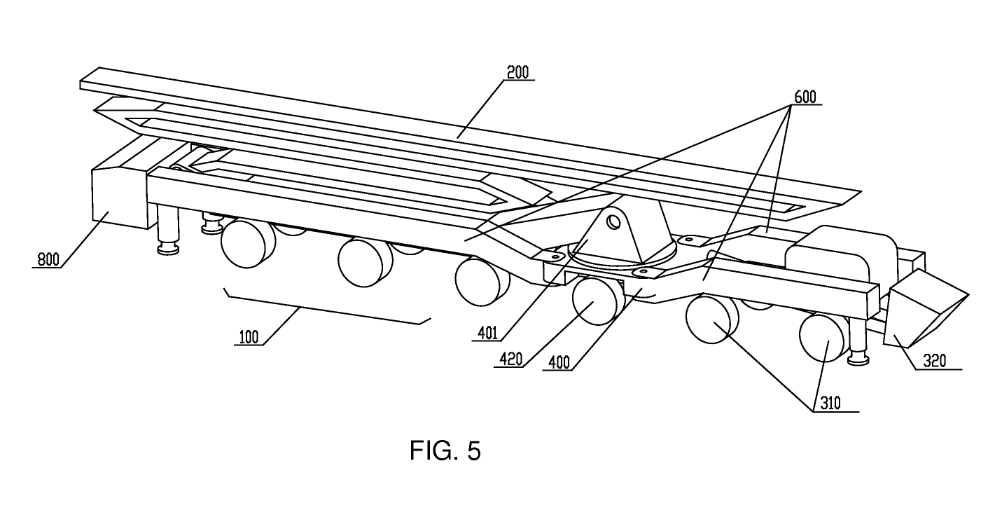

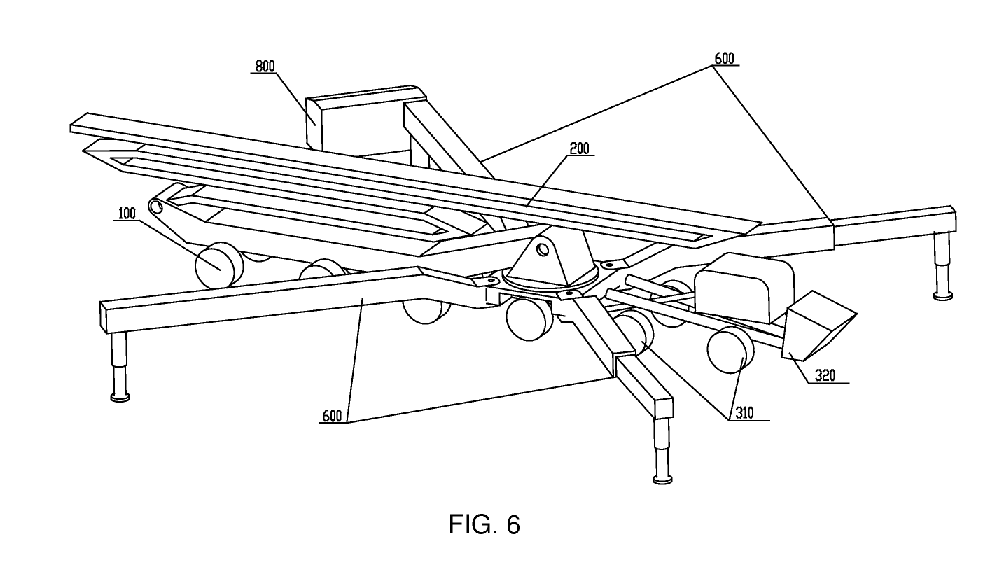

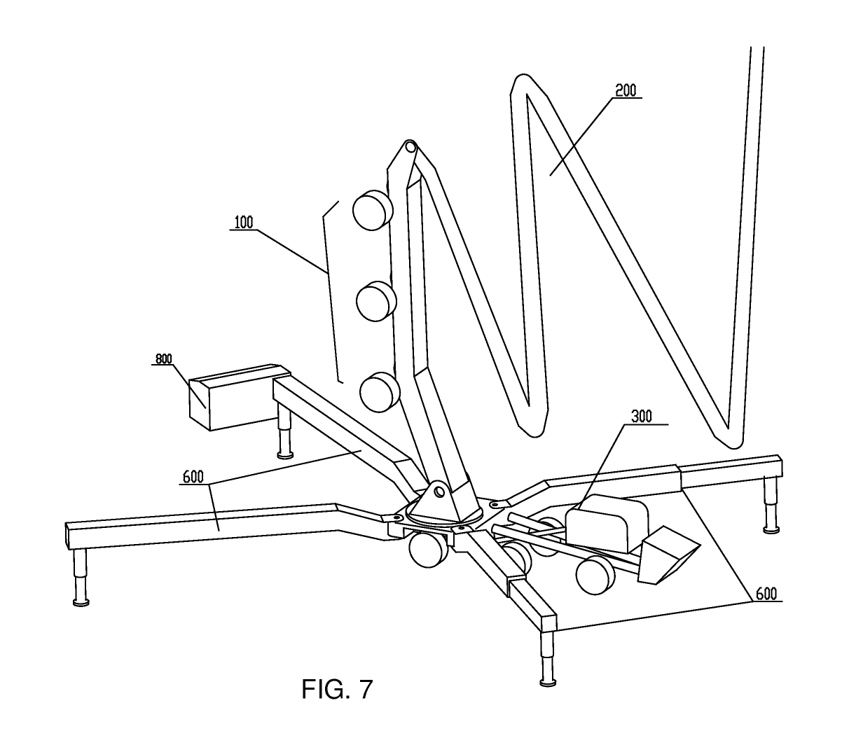

Referring to FIG. 5 to FIG. 7, FIG. 5 shows a wheeled material distributing machinery according to Embodiment 2 of the present disclosure, and is a schematic structural view of the wheeled material distributing machinery is in a travel state; FIG. 6 is a schematic structural view of an unfolded outrigger mechanism in a wheeled material distributing machinery according to Embodiment 2 of the present disclosure; and FIG. 7 is a schematic structural view of a wheeled material distributing machinery according to Embodiment 2 of the present disclosure in a predetermined working state.

Compared with the wheeled material distributing machinery according to Embodiment 1, in the wheeled material distributing machinery according to Embodiment 2, the slewing centerline of the slewing mechanism is perpendicular to the horizontal plane in both the travel state and predetermined working state. In this way, during state switching of the wheeled material distributing machinery, it is unnecessary to turn the slewing mechanism, and hence it is unnecessary to turn the material distributing frame 400. As it is unnecessary to turn the material distributing frame 400, in this embodiment, the inner end of each outrigger mechanism 600 may be connected to the material distributing frame 400 in the same manner, that is, the inner ends of all the outrigger mechanisms 600 are hinge-connected to the material distributing frame 400 through an outrigger hinge-connecting shaft, and the axis of the outrigger hinge-connecting shaft is parallel with the slewing centerline. To facilitate the folding of the outrigger mechanisms 600, in this embodiment, two of the four outrigger mechanisms 600 extend forward and another two of the four outrigger mechanisms 600 extend backward in the travel state. In order to reduce the front and rear size of the wheeled material distributing machinery in the travel state, the two outrigger mechanisms 600 extending backward have a telescopic structure and the two outrigger mechanism 600 extending backward are folded in the travel state.

Referring to FIG. 6, when the outrigger mechanisms 600 are unfolded, each outrigger mechanism 600 is first enabled to rotate about the axis of the corresponding outrigger hinge-connecting shaft for a certain angle, and then the outer end of the outrigger mechanism 600 is supported on the working surface, to maintain the stability of the material distributing frame 400. Subsequently, the root end boom 210 is enabled to turn relative to the material distributing frame 400 through a drive cylinder of the boom system 200 (or other auxiliary crane devices), so that the wheeled material distributing machinery is switched to the corresponding working state, and then the boom system 200 is controlled in an existing manner, thereby implementing the material distributing. The outrigger mechanisms 600 and the material distributing frame 400 are parallel with the slewing centerline through the axis, and are hinge-connected to the outrigger hinge-connecting shaft that is basically perpendicular to the horizontal plane, which not only facilitates the state switching of the wheeled material distributing machinery, but also improves the stability and reliability of support provided by the outrigger mechanisms 600 for the material distributing frame 400 and improves the stability and reliability of the wheeled material distributing machinery.

As shown in FIG. 5, to reasonably distribute the load of the wheeled material distributing machinery and ensure the stability of the travel state, Embodiment 2 further provides a frame auxiliary travel system 420, and an axle assembly of the frame auxiliary travel system 420 is mounted on the material distributing frame 400. In this way, in the travel state, the axle assembly of the frame auxiliary travel system 420 contacts the ground, and the weight of the material distributing frame 400 basically acts on the frame auxiliary travel system 420, thereby improving the travel stability and flexibility of the wheeled material distributing machinery. In specific cases, the weight of the material distributing frame 400 may act on the root end boom 210, and then act on the main travel system 100 through the root end boom 210.

To facilitate arrangement of the control mechanism in the operating cab 800 and avoid an operation position change resulting from the state switching, in Embodiment 2, the operating cab 800 is disposed on outer ends of the outrigger mechanisms 600 extending forward. In this way, during state switching of the wheeled material distributing machinery, the operating cab 800 no longer turns along with the root end boom 210 (or other booms), thereby further facilitating the arrangement of the travel control mechanism and pumping control mechanism, and facilitating operations of operation personnel; as the height of the operating cab 800 is reduced, the operation safety is also improved.

In order to guarantee relative positions of the pumping assembly 300 and the material distributing frame 400 and facilitate a connection between a pumping port of the pumping system 320 and a delivery pipeline of the boom system 200, a proper connection mechanism may be formed between the pumping assembly 300 and the material distributing frame 400; an exemplary manner is to make the pumping assembly 300 be hinge-connected to the material distributing frame 400.

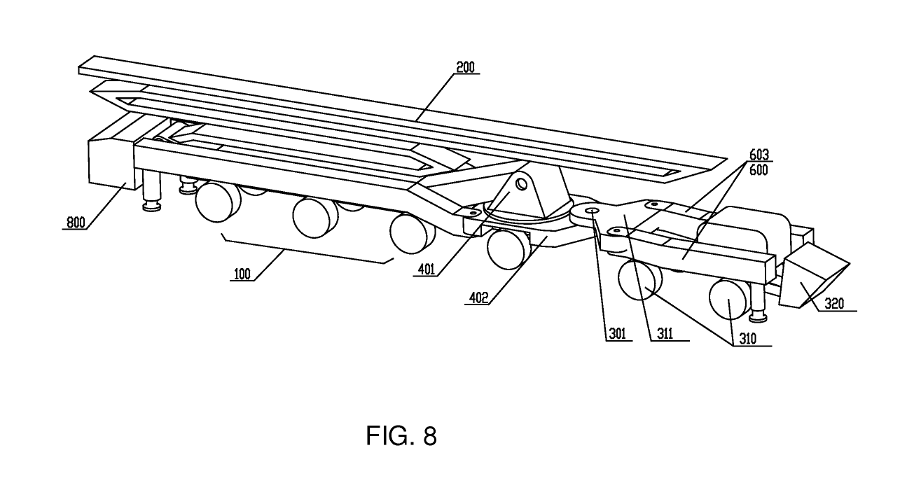

Referring to FIG. 8, FIG. 8 is a schematic structural view of a wheeled material distributing machinery according to Embodiment 3 of the present disclosure. In this embodiment, the slewing centerline of the slewing mechanism is basically perpendicular to the horizontal plane in both the predetermined working state and travel state. During state switching, the material distributing frame 400 does not need to perform the state switching. The weight of the pumping system 320 acts on a pump auxiliary travel system 310, and the pump auxiliary travel system 310 includes a pumping support 311 and an axle assembly connected to the pumping support 311. The pumping support 311 is connected to a middle hinge-connecting shaft 301 through the material distributing frame 400, and is perpendicular to the horizontal plane (when the material distributing frame 400 includes a slewing mechanism, the pumping support 311 is specifically connected to the fixed component 402). In this way, relative positions of the pumping system 320 and the material distributing frame 400 may be determined through the middle hinge-connecting shaft 301, thereby facilitating the connection between the pumping port of the pumping system 320 and the delivery pipeline of the boom system 200, and improving the stability of the material delivery. It is understandable that, at this time, the weight of the pumping system 320 is partially delivered to the material distributing frame 400 through the hinge-connection part, and part of the weight of the pumping system 320 acts on the pump auxiliary travel system 310, which is conducive to reasonable distribution of load of the wheeled material distributing machinery. Definitely, in other cases, partial weight of the pumping system 320 may be delivered to other parts through a corresponding structure.

To guarantee the working stability of the pumping system 320, in this embodiment, an outrigger mechanism 600 hinge-connected to the pumping support 311 is further provided (to be distinguishable, this outrigger mechanism 600 is marked as 603). An inner end of the outrigger mechanism 603 is hinge-connected to the pumping support 311 through an outrigger hinge-connecting shaft, and the axis of the outrigger hinge-connecting shaft is parallel with the axis of the middle hinge-connecting shaft 301. In the corresponding working state, an outer end of the outrigger mechanism 603 is supported on the working surface, and provides a support force for the pumping support 311, thereby improving the stability of the pumping system 320.

According to the present disclosure, in the one embodiment of the wheeled material distributing machinery, a main travel system 100 is mounted on a boom system 200, and a material distributing frame 400 is provided. The main travel system 100 facilitates a transition operation of the wheeled material distributing machinery; in a predetermined working state, the material distributing frame 400 is supported on a working surface, and provides a basis for a material distributing operation. During state switching, a position of the main travel system 100 can be switched along with the boom system 200. Furthermore, another wheeled material distributing machinery provided in the present disclosure includes a main travel system 100, a boom system 200, and a material distributing frame 400; a root end boom 210 of the boom system 200 is hinge-connected to the material distributing frame 400 through a root end hinge-connecting shaft 211; and the main travel system 100 is mounted on a predetermined boom of the boom system 200. The boom system 200 and the main travel system 100 are capable of rotating about the axis of the root end hinge-connecting shaft 211 relative to the material distributing frame 400 under the effect of an appropriate mechanism. Loads of the boom system 200 and the main travel system 100 may be distributed according to an actual requirement, so as to meet the transition requirement in the travel state, and meet a material distributing requirement in a predetermined working state.

In another embodiment, a wheeled material distributing machinery provided in the present disclosure includes a main travel system 100, a boom system 200 and a material distributing frame 400; a root end boom 210 of the boom system 200 is connected to the material distributing frame 400. This wheeled material distributing machinery differs from the foregoing wheeled material distributing machinery in that, the main travel system 100 is mounted on a predetermined boom of the boom system 200 through a removable mechanism. In this way, during a transition operation, with the removable mechanism, the connection between the main travel system 100 and the boom system 200 is maintained; during a material distributing, operation, the main travel system 100 is separated from the boom system 200, so that the material distributing frame 400 is supported on a predetermined working surface. The boom system 200 is controlled using a method in the prior art to implement the material distributing operation.

The technical content contained in the technical solutions described above may be combined according to an actual requirement, so as to form a corresponding technical solution to solve the corresponding technical problem, thereby meeting the actual requirement.

Specific examples are used herein to illustrate the technical solution provided in the present disclosure, and the description of the above embodiments is merely provided to make the technical solution of the present disclosure more comprehensive. It should be noted that, persons of ordinary skills in the art may make further improvement and modification on the present disclosure without departing from the principle of the present disclosure; for example, as the material distributing frame 400 bears a heavy load, an outrigger mechanism 600 with an inner end connected to the material distributing frame 400 may be disposed according to an actual requirement; a corresponding outrigger auxiliary travel system may be provided according to the actual weight of the outrigger mechanism 600, to bear the load formed by the outrigger mechanism 600; the operating cab 800 is not limited to being disposed on an outrigger mechanism 600 extending upward, but may also be disposed at an outer end of a corresponding outrigger mechanism 600 or other parts of the outrigger mechanism according to an actual control requirement; definitely, the operating cab 800 is not limited to being disposed at the outer end of the root end boom 210, but may also be disposed on a proper part of another boom; such improvement and modification also fall within the protection scope of the claims of the present disclosure.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to activate others skilled in the art to utilize the disclosure and various embodiments and with various modifications as are suited to the particular use contemplated. Alternative embodiments will become apparent to those skilled in the art to which the present disclosure pertains without departing from its spirit and scope. Accordingly, the scope of the present disclosure is defined by the appended claims rather than the foregoing description and the exemplary embodiments described therein

What is claimed is:

1. A wheeled material distributing machinery, comprising:
a main travel system (100);
a boom system (200); and
a material distributing frame (400),
wherein an inner end of a root end boom (210) of the boom system (200) is connected to the material distributing frame (400), and the main travel system (100) is mounted on a predetermined boom of the boom system (200);
wherein in a travel state, the main travel system (100) is supported on a road surface, and at least part of the weight of the boom system (200) and at least part of the weight of the material distributing frame (400) act on the main travel system (100); and
wherein in a predetermined working state, the material distributing frame (400) is supported on a working surface, and the entire weight of the boom system (200) and the entire weight of the main travel system (100) both act on the material distributing frame (400).

2. The wheeled material distributing machinery according to claim 1, wherein the predetermined boom is the root end boom (210) of the boom system (200).

3. The wheeled material distributing machinery according to claim 1, wherein the main travel system (100) comprises a vehicle frame and multiple axle assemblies mounted on the vehicle frame, and the vehicle frame is fixedly mounted on the predetermined boom of the boom system (200).

4. The wheeled material distributing machinery according to claim 1, wherein the main travel system (100) comprises multiple axle assemblies, the axle assemblies are mounted on the predetermined boom of the boom system (200), and at least one of the multiple axle assemblies is an axle assembly capable of steering.

5. The wheeled material distributing machinery according to claim 4, wherein at least one of the axle assemblies is an axle assembly having an independent drive mechanism.

6. The wheeled material distributing machinery according to claim 1, wherein the material distributing frame (400) comprises a slewing mechanism, the slewing mechanism comprises a rotary component (401) and a fixed component (402) that form a rotatable fit, the rotary component (401) is connected to the inner end of the root end boom (210), and in the predetermined working state, a slewing centerline of the slewing mechanism is perpendicular to a horizontal plane.

7. The wheeled material distributing machinery according to claim 6, wherein the rotary component (401) is hinge-connected to the inner end of the root end boom (210) through a root end hinge-connecting shaft (211); the axis of the root end hinge-connecting shaft (211) is perpendicular to the slewing centerline; in the predetermined working state, the axis of the root end hinge-connecting shaft (211) is parallel with the horizontal plane; a boom drive mechanism is further comprised, the boom drive mechanism is located between the root end boom (210) and the rotary component (401) and drives the root end boom (210) to rotate about the axis of the root end hinge-connecting shaft (211) relative to the rotary component (401).

8. The wheeled material distributing machinery according to claim 6, wherein in the travel state, the slewing centerline of the slewing mechanism and the horizontal plane are parallel with each other or form an acute angle; at least three outrigger mechanisms (600) are further comprised; an inner end of at least one outrigger mechanism (602) is hinge-connected to a rotating block (410) through an outrigger hinge-connecting shaft, the rotating block (410) is hinge-connected to the fixed component (402) through a rotary hinge-connecting shaft (411), the axis of the outrigger hinge-connecting shaft is perpendicular to the axis of the rotary hinge-connecting shaft (411), the axis of the rotary hinge-connecting shaft (411) is parallel with the slewing centerline; in the predetermined working state, the axis of the outrigger hinge-connecting shaft is parallel with the horizontal plane, and the material distributing frame (400) is supported on the working surface through the outrigger mechanisms (600).

9. The wheeled material distributing machinery according to claim 8, wherein an inner end of at least one outrigger mechanism (601) is hinge-connected to the fixed component (402) through an outrigger hinge-connecting shaft, and the axis of the outrigger hinge-connecting shaft is perpendicular to the slewing centerline.

10. The wheeled material distributing machinery according to claim 6, wherein in both the travel state and the predetermined working state, the slewing centerline of the slewing mechanism is perpendicular to the horizontal plane;
at least three outrigger mechanisms (600) are further comprised; an inner end of each of the outrigger mechanisms (600) is hinge-connected to the fixed component (402) through an outrigger hinge-connecting shaft, the axis of the outrigger hinge-connecting shaft is parallel with the slewing centerline; in the predetermined working state, the material distributing frame (400) is supported on the working surface through the outrigger mechanisms (600).

11. The wheeled material distributing machinery according to claim 1, further comprising a pumping assembly connected to the material distributing frame (400), wherein the pumping assembly comprises a pumping system (320) and a pump auxiliary travel system (310) connected to the pumping system (320).

12. The wheeled material distributing machinery according to claim 11, wherein the material distributing frame (400) comprises a slewing mechanism, the slewing mechanism comprises a rotary component (401) and a fixed component (402) that form a rotatable fit, the rotary component (401) is connected to the inner end of the root end boom (210); in both the travel state and the predetermined working state, a slewing centerline of the slewing mechanism is perpendicular to a horizontal plane; in the travel state and/or the predetermined working state, a pumping support (311) of the pump auxiliary travel system (310) is connected to the fixed component (402) through a middle hinge-connecting shaft (301), and the axis of the middle hinge-connecting shaft (301) is perpendicular to the horizontal plane.

13. The wheeled material distributing machinery according to claim 12, further comprising an outrigger mechanism (600) hinge-connected to the pumping support (311) through an outrigger hinge-connecting shaft, wherein the axis of the outrigger hinge-connecting shaft is parallel with the axis of the middle hinge-connecting shaft (301).

14. The wheeled material distributing machinery according to claim 1, further comprising a turning drive mechanism connected to the boom system (200), wherein when the wheeled material distributing machinery switches from the travel state to the predetermined working state, the turning drive mechanism is supported on the ground, and drives the boom system (200) to turn.

15. The wheeled material distributing machinery according to claim 1, further comprising a turning drive mechanism connected to the boom system (400), wherein when the wheeled material distributing machinery switches from the travel state to the predetermined working state, the turning drive mechanism is supported on the ground, and drives the boom system (400), or the boom system (200) and the material distributing frame (400) to turn.

16. The wheeled material distributing machinery according to claim 8, further comprising an outrigger auxiliary travel system (700), wherein the outrigger auxiliary travel system (700) is mounted on at least one outrigger mechanism (600), and in the travel state, the outrigger auxiliary travel system (700) is supported on the road surface, and the weight of at least one outrigger mechanism (600) acts on the outrigger auxiliary travel system (700).

17. The wheeled material distributing machinery according to claim 8, further comprising an operating cab (800) located on an outrigger mechanism (600), wherein the operating cab (800) comprises a travel control mechanism, and the travel control mechanism is capable of controlling operation of the main travel system (100).

18. The wheeled material distributing machinery according to claim 1, further comprising a frame auxiliary travel system (420), wherein an axle assembly of the frame auxiliary travel system (420) is mounted on the material distributing frame (400), and in the travel state, the axle assembly of the frame auxiliary travel system (420) is supported on the road surface.

19. The wheeled material distributing machinery according to claim 1, further comprising a state detection sensor and a controller, wherein the state detection sensor is used to detect a state of the root end boom (210), and the controller outputs a position signal according to a detection signal of the state detection sensor.

20. The wheeled material distributing machinery according to claim 19, wherein the state detection sensor is a tilt-angle sensor, the tilt-angle sensor detects a tilt angle of the root end boom (210), and the controller determines, according to a detection result of the tilt-angle sensor, whether state switching is completed, and when it is determined that the state switching is completed, outputs a predetermined position signal.

21. The wheeled material distributing machinery according to claim 1, further comprising an operating cab (800) located on a predetermined boom of the boom system (200), wherein the operating cab (800) comprises a travel control mechanism, and the travel control mechanism is capable of controlling operation of the main travel system (100).

22. A wheeled material distributing machinery, comprising:
a main travel system (100);
a boom system (200); and
a material distributing frame (400),
wherein a root end boom (210) of the boom system (200) is hinge-connected to the material distributing frame (400) through a root end hinge-connecting shaft (211), the main travel system (100) is mounted on a predetermined boom of the boom system (200), and the boom system (200) and the main travel system (100) are capable of rotating about the axis of the root end hinge-connecting shaft (211) together relative to the material distributing frame (400).

23. The wheeled material distributing machinery according to claim 22, further comprising a pumping assembly connected to the material distributing frame (400), wherein the pumping assembly comprises a pumping system (320) and a pump auxiliary travel system (310) connected to the pumping system (320), and the pumping system (320) is in communication with a delivery pipeline of the boom system (200) through piping.

24. The wheeled material distributing machinery according to claim 22, wherein the material distributing frame (400) comprises a rotary component (401) and a fixed component (402) that form a rotatable fit, and the rotary component (401) is hinge-connected to an inner end of the root end boom (210) through the root end hinge-connecting shaft (211).

25. The wheeled material distributing machinery according to claim 22, wherein the main travel system (100) comprises multiple axle assemblies, the axle assemblies are mounted on the predetermined boom of the boom system (200), and at least one of the multiple axle assemblies is an axle assembly capable of steering.

26. The wheeled material distributing machinery according to claim 22, further comprising at least three outrigger mechanisms (600), wherein an inner end of at least one outrigger mechanism (602) is hinge-connected to a rotating block (410) through an outrigger hinge-connecting shaft, the rotating block (410) is hinge-connected to the material distributing frame (400) through a rotary hinge-connecting shaft (411), the axis of the outrigger hinge-connecting shaft is perpendicular to the axis of the rotary hinge-connecting shaft (411), an inner end of at least another outrigger mechanism (601) is hinge-connected to the material distributing frame (400) through an outrigger hinge-connecting shaft, and the axis of the outrigger hinge-connecting shaft is perpendicular to the axis of the rotary hinge-connecting shaft (411).

27. The wheeled material distributing machinery according to claim 26, further comprising an operating cab (800) located on the predetermined boom of the boom system (200) or the outrigger mechanism (600), wherein the operating cab (800) comprises a travel control mechanism capable of controlling operation of the main travel system (100).

28. The wheeled material distributing machinery according to claim 22, further comprising at least three outrigger mechanisms (600), wherein an inner end of each of the outrigger mechanisms (600) is hinge-connected to the material distributing frame (400) through an outrigger hinge-connecting shaft, and in a predetermined working state, the axis of the outrigger hinge-connecting shaft is perpendicular to a horizontal plane.

29. The wheeled material distributing machinery according to claim 28, further comprising an operating cab (800) located on the predetermined boom of the boom system (200) or the outrigger mechanism (600), wherein the operating cab (800) comprises a travel control mechanism capable of controlling operation of the main travel system (100).

30. A wheeled material distributing machinery, comprising:
a main travel system (100);
a boom system (200); and
a material distributing frame (400),
wherein a root end boom (210) of the boom system (200) is connected to the material distributing frame (400), and the main travel system (100) is mounted on a predetermined boom of the boom system (200) through a removable mechanism.
